(19) United States
(12) Patent Application Publication
(10) Pub. No.: US 2007/0137976 A1
(43) Pub. Date: Jun. 21, 2007

(54) SLEEVE ASSEMBLY

(76) Inventor: Brian Cole, Kendallville, IN (US)

Correspondence Address: TAYLOR & AUST, P.C., 142 SOUTH MAIN STREET, P. O. BOX 560, AVILLA, IN, 46710, US

(21) Appl. No.: 11/610,756

(22) Filed: Dec. 14, 2006

Related U.S. Application Data
(60) Provisional application No. 60/750,528, filed on Dec. 15, 2005.

(51) Int. Cl. F16D 13/58

(52) U.S. Cl. 192/110 B

(57) ABSTRACT

A vehicle having a power unit and a drive train. The drive train is connected to the power unit. The drive train includes a transmission having a shaft and a clutch assembly connected to the transmission. The clutch assembly has a retaining structure and a sleeve. The sleeve is in contact with the retaining structure and the shaft extends through the sleeve. The sleeve includes a body and a ring removably attached to an outer surface of the body. The body has at least one internal substantially cylindrically shaped bearing surface. The body also has an outer surface and a first hardness. The ring has a second hardness different from the first hardness.

### CROSS REFERENCE TO RELATED APPLICATIONS

This is a non-provisional application based upon U.S. provisional patent application Ser. No. 60/750,528, entitled “SNAP RING ASSEMBLY”, filed Dec. 15, 2005.

### BACKGROUND OF THE INVENTION

1. Field of the Invention

The present invention relates to a clutch assembly, and, more particularly, to a clutch assembly utilizing a sleeve assembly.

2. Description of the Related Art

Vehicles include a power train system that has a power source, such as an internal combustion engine and a transmission for the coupling of the power from the engine to a drive shaft and/or directly to a wheel mechanism. Located between the engine and the transmission is a clutch assembly, often with a friction plate and a clutch release device having an operating mechanism to controllably disengage the engine from the transmission, either with an automatic control system or by the manual depressing of a clutch pedal in the vehicle. While clutch assemblies are commonly used in vehicles, clutch assemblies can exist in any power system in which mechanical motion needs to be controllably engaged and disengaged from a driven mechanism. A rotating portion of the engine includes a flywheel with a generally flat surface against which a friction plate is held under compression when the drive train is being driven. A releasing linkage relieves the pressure against the friction plate allowing it to become uncoupled from the flywheel of the engine, thereby disengaging the power unit from the driven portion of the mechanism.

Internal to the clutch assembly there is typically a shaft that extends from a transmission for the conveying of rotary motion thereto. A shaft is coupled to the friction plate for transfer of rotational power to a transmission. Often the shaft will have splined areas for the interconnection of the shaft with driving and/or driven portions of the assembly. A sleeve assembly is utilized to direct the shaft and provide a bearing surface therefor.

Sleeve assemblies normally require swedging, machining or the bonding of two materials and subsequent partial heat-treating to achieve a hardened portion for the retention of the sleeve while retaining a machinable portion for the machining of the bearing surface.

What is needed in the art is a sleeve assembly that can be manufactured without the need for bonding two materials of different hardnesses to the sleeve assembly structure or to partially harden the sleeve.

### SUMMARY OF THE INVENTION

The present invention provides a sleeve assembly for use in a clutch assembly.

The invention in one form is directed to a vehicle having a power unit and a drive train. The drive train is connected to the power unit. The drive train includes a transmission having a shaft and a clutch assembly connected to the transmission. The clutch assembly has a retaining structure and a sleeve. The sleeve is in contact with the retaining structure and the shaft extends through the sleeve. The sleeve includes a body and a ring removably attached to an outer surface of the body. The body has at least one internal substantially cylindrically shaped bearing surface. The body also has an outer surface and a first hardness. The ring has a second hardness different from the first hardness.

An advantage of the present invention is that it allows the body to be easily machined without the ring.

Another advantage of the present invention is that unlike prior art sleeve assemblies, the body does not undergo a full or a partial heat treatment for hardening a portion thereof.

Yet another advantage of the present invention is that it can be easily assembled.

Still yet another advantage of the present invention is that it reduces the cost of making a sleeve assembly over that of the prior art.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 illustrates a partially sectioned vehicle having a clutch assembly that utilizes an embodiment of a sleeve assembly of the present invention;

FIG. 2 is a simplified perspective view of a sleeve assembly installed in the clutch assembly of FIG. 1;

FIG. 3 is an end view of the sleeve assembly used in the clutch assemblies of FIGS. 1 and 2;

FIG. 4 is a sectioned side view of the body of the sleeve assembly of FIG. 3;

FIG. 5 is an end view of a ring utilized in sleeve assembly of FIG. 3;

FIG. 6 is a sectioned side view of the ring of FIG. 5; and

FIG. 7 is a partial sectioned view showing details of the clutch assembly, and the sleeve assembly of FIGS. 3-6 used in the clutch assembly of FIGS. 1 and 2.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

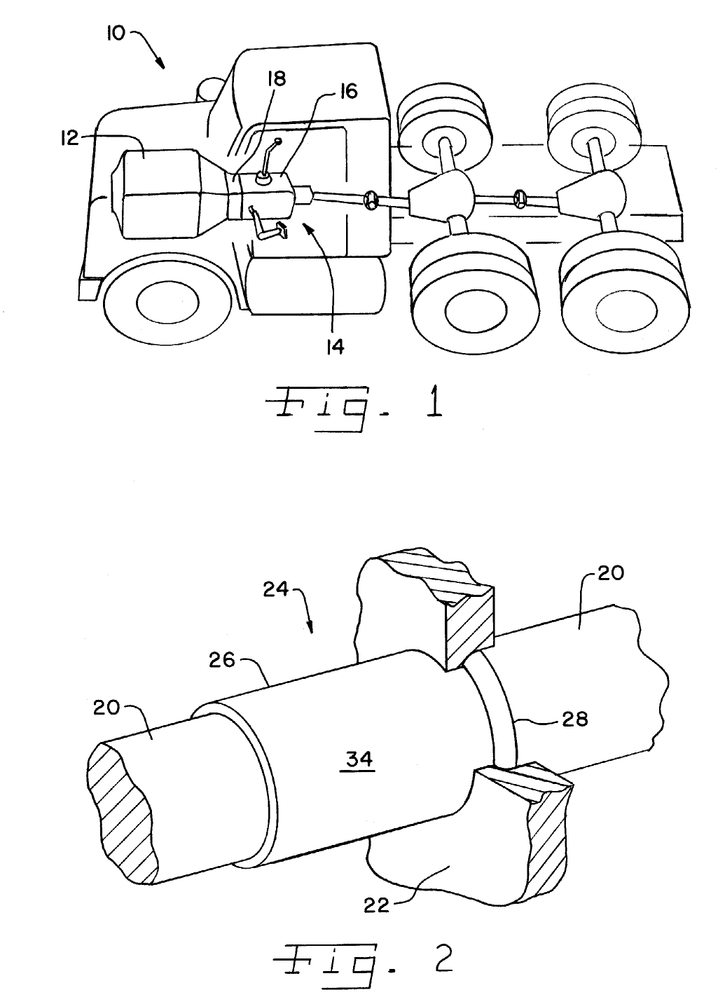

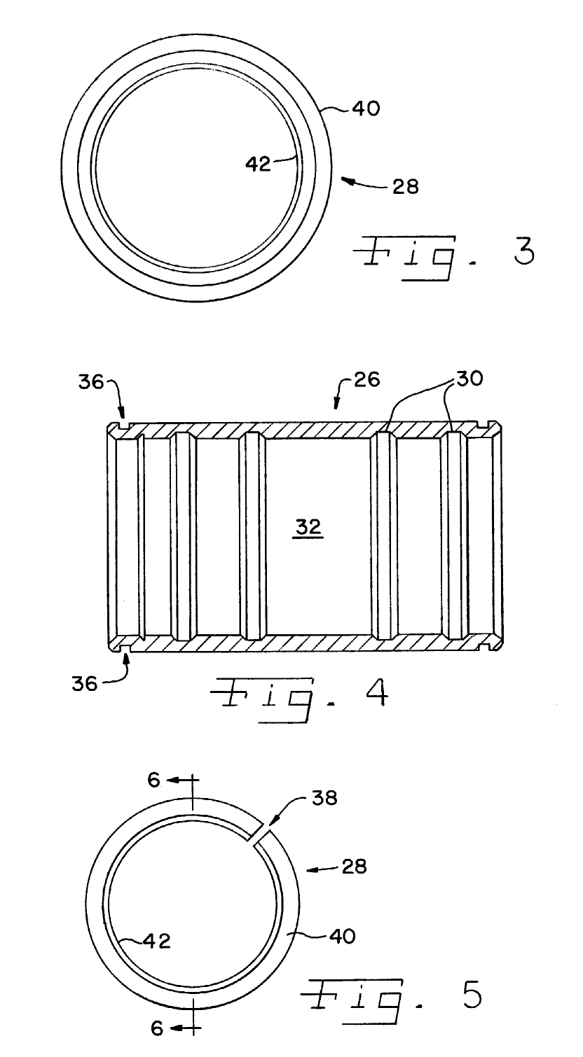

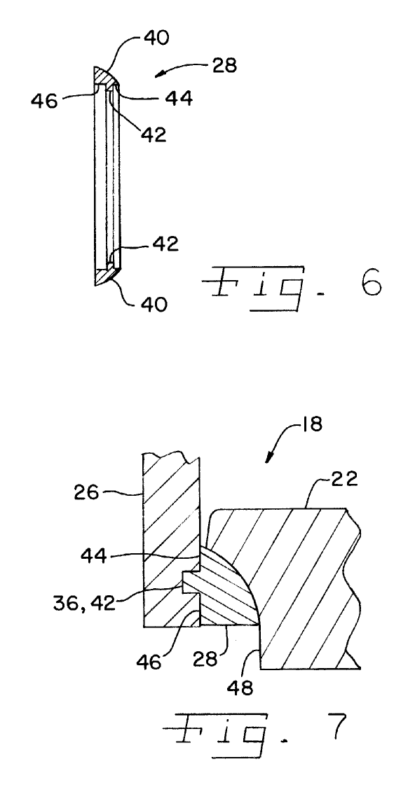

Referring now to the drawings, and more particularly to FIG. 1, there is shown a vehicle 10 having an engine 12, a drive train 14. Engine 12, also known as a power unit 12 supplies power to vehicle 10 and provides auxiliary power to the systems of vehicle 10. Drive train 14 includes a transmission 16 and a clutch assembly 18 that operatively connects engine 12 with transmission 16. Clutch assembly 18 may include a frictional element for the coupling of rotational movement of engine 12 to transmission 16.

Clutch assembly 18 includes a retaining structure 22 and a sleeve assembly 24. Shaft 20, usually from a transmission 16, extends through sleeve assembly 24 and power is transmitted by way of shaft 20 to transmission 16. Retaining structure 22 may be connected to a housing or a movable portion of clutch assembly 18 and restrains lateral movement of sleeve assembly 24 relative to retaining structure 22. Sleeve assembly 24 also known as sleeve 24 provides a bearing surface for the rotation of shaft 20 therein. Sleeve assembly 24 accommodates shaft 20 and allows some angular movement of sleeve 24 with shaft 20 so that sleeve 24 may be part of a self-centering clutch assembly 18. Sleeve 24 may have a loose tolerance relative to the surface of shaft 20, since sleeve 24 does not provide a support for shaft 20. To a large extent sleeve 20 orients itself with shaft 20.

Sleeve 24 includes a body 26 and a ring 28. Ring 28 is releasably connected to body 26 for ease of assembly and disassembly. Body 26 has a hardness that is less than that of ring 28 thereby allowing the hardness of ring 28, which interacts with retaining structure 22 to be more durable and meet the requirements of its interaction with retaining structure 22. Body 26 includes internal annular grooves 30, which may retain a lubricating medium, such as grease. Body 26 additionally includes bearing surfaces 32, an outer surface 34 and an annular groove 36. Bearing surfaces 32 may have spiral grooves cut therein for the distribution of lubrication. Bearing surfaces 32 may be machined from body 26 or may be another material retained within body 26. Outer surface 34 has an annular groove 36 cut therein, for the retention of ring 28. Although shown as a groove 36, a protrusion could also be utilized with a ring having a complimentary groove therein. For ease of explanation and illustration annular groove 36 is shown with ring 28 having a protrusion therefrom that interacts with annular groove 36. It is contemplated that complimentary surfaces can also be utilized.

Ring 28 includes a split 38, an outer surface 40, an annular protrusion 42 with shoulders 44 and 46 adjacent thereto. Split 38 is shown as a straight split, for simplicity of illustration, and may be angular or some other shape. Split 38 allows ring 28 to be expanded so as to be pushed into position on outer surface 34 so that annular protrusion 42 seats in annular groove 36. When ring 28 is seated on body 26, shoulders 44 and 46 are in contact with outer surface 34.

Outer surface 40 of ring 28 has a substantially spherical convex shape allowing sleeve assembly 24 to rotate in an angular manner as it interacts with surface 48 of sleeve assembly 24. Surface 48 has a concave semi-spherical shape that is complimentary to outer surface 40 of ring 28. The interaction of outer surface 40 and surface 48 also causes ring 28 to remain seated in annular groove 36. Additionally, the natural resiliency of ring 28 provides a biasing force to hold protrusion 42 of ring 28 in annular groove 36.

Advantageously, ring 28 is made of material that is hardened while the balance of sleeve assembly 24 is less expensively manufactured. The clutch assembly of the present invention may be utilized in heavy and light duty trucks, in agricultural vehicles, in off-highway vehicles, in marine applications, in construction equipment, and in petroleum industries including drilling rig pump stations and refineries.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A vehicle, comprising:
a power unit; and
a drive train connected to said power unit, said drive train including:
a transmission having a shaft; and
a clutch assembly connected to said transmission, said clutch assembly having:
a retaining structure; and
a sleeve in contact with said retaining structure, said shaft extending through said sleeve, said sleeve including:
a body having at least one internal substantially cylindrically shaped bearing surface, said body having an outer surface, said body having a first hardness; and
a ring removably attached to said outer surface, said ring having a second hardness different from said first hardness.

2. The vehicle of claim 1, wherein said ring is split.

3. The vehicle of claim 2, wherein said body includes one of an annular groove and an annular protrusion to retain said ring.

4. The vehicle of claim 3, wherein said body includes an annular groove.

5. The vehicle of claim 4, wherein said ring includes an inwardly directed annular protrusion that cooperates with said annular groove to retain said ring to said body.

6. The vehicle of claim 5, wherein said ring has an outer surface, said retaining structure having a surface in contact with said outer surface thereby restraining lateral movement of said sleeve.

7. The vehicle of claim 6, wherein said outer surface of said ring has a substantially spherical convex shape.

8. The vehicle of claim 7, wherein said surface of said retaining structure has a shape complimentary to said outer surface of said ring.

9. The vehicle of claim 1, wherein said second hardness is greater than said first hardness.

10. A clutch assembly having:
a retaining structure; and
a sleeve in contact with said retaining structure, said sleeve including:
a body having at least one internal substantially cylindrically shaped bearing surface, said body having an outer surface, said body having a first hardness; and
a ring removably attached to said outer surface, said ring having a second hardness different from said first hardness.

11. The clutch assembly of claim 10, wherein said second hardness is greater than said first hardness.

12. The clutch assembly of claim 11, wherein said ring is split.

13. The clutch assembly of claim 2, wherein said body includes one of an annular groove and an annular protrusion to retain said ring.

14. The clutch assembly of claim 13, wherein said body includes an annular groove.

15. The clutch assembly of claim 14, wherein said ring includes an inwardly directed annular protrusion that cooperates with said annular groove to retain said ring to said body.

16. The clutch assembly of claim 15, wherein said ring has an outer surface, said retaining structure having a surface in contact with said outer surface thereby restraining lateral movement of said sleeve.

17. The clutch assembly of claim 16, wherein said outer surface of said ring has a substantially spherical convex shape.

18. The clutch assembly of claim 17, wherein said surface of said retaining structure has a shape complimentary to said outer surface of said ring.

19. A sleeve for use in a clutch, the sleeve comprising:
a body having at least one internal substantially cylindrically shaped bearing surface, said body having an outer surface with an annular groove therein, said body having a first hardness; and
a ring removably attached to said outer surface, said ring having a second hardness, said second hardness being greater than said first hardness.

20. The sleeve of claim 19, wherein said ring includes an inwardly directed annular protrusion that cooperates with said annular groove to retain said ring to said body.
